(19) United States
(12) Patent Application Publication
(10) Pub. No.: US 2006/0277568 A1
(43) Pub. Date: Dec. 7, 2006

(54) Method and system for making compensation for advertising on display device of home appliance

(76) Inventors: Yong Tae Kim, Gimhae-si (KR); Eun Jeong Kim, Changwon-si (KR); Jong Min Shin, Busan (KR); Sun Cheol Bae, Masan-si (KR); Ku Young Son, Busan (KR); Yong Chol Kwon, Changwon-si (KR); Jae Seng Sim, Masan-si (KR); Su Won Lee, Changwon-si (KR)

Correspondence Address: FLESHNER & KIM, LLP, P.O. BOX 221200, CHANTILLY, VA, 20153, US

(21) Appl. No.: 11/432,718

(22) Filed: May 12, 2006

(30) Foreign Application Priority Data
May 13, 2005 (KR) P2005-0040195

(51) Int. Cl. H04N 7/025; H04N 7/10; G06F 13/00; H04N 5/445

(52) U.S. Cl. 725/34; 725/35; 725/46

(57) ABSTRACT

Method for making compensation for advertising on a display device of a home appliance including the steps of displaying a predetermined advertisement data on a display device of the home appliance, producing a display result data on a result of the display of the advertisement data, accumulating electronic cash of a predetermined amount for the user of the home appliance according to the display result data.

### CROSS-REFERENCE TO RELATED APPLICATION

This application claims the benefit of Korean Application No. P2005-0040195 filed on May 13, 2005, which is hereby incorporated by reference as if fully set forth herein.

### BACKGROUND OF THE INVENTION

1. Field of the Invention

The present invention relates to method and system for making compensation for advertising on a display device of a home appliance, and more particularly, to method and system for making compensation to a user for advertising on a display device of a home appliance.

2. Discussion of the Related Art

The home appliance has a variety of functions for the convenience of user. For an example, a related art refrigerator enables, not only to store food, but also to obtain ice personally, or make a temperature of a refrigerating chamber or freezing chamber known in real time. In order to make a user to be able to notice or control such functions of the refrigerator, the refrigerator is provided with a display device, such as an LCD panel.

A user interface is displayed on such a display device, with numerals, characters, or icons for the temperatures of the refrigerating chamber, and the freezing chamber, and a service state of a dispenser (water, ice cubes, and so on).

The display device is also provided with an input device (for an example, buttons) for controlling the temperatures of the refrigerating chamber and the freezing chamber, and service of the dispenser.

FIG. 1 illustrates a diagram of a display device of a related art refrigerator.

Referring to FIG. 1, the display device displays a service mode of the dispenser (ice cube, water, or crushed ice), a set temperature of the freezing chamber, and a set temperature of the refrigerating chamber, and is provided with an input means on a lower side.

Such a related art home appliance, for an example, the refrigerator, has merely been provided with a function for displaying an operation state of the refrigerator. Therefore, the related art home appliance can not display information obtainable from peripheral home appliances of the refrigerator. Particularly, the related art home appliance neither displays advertisement the user desires, nor provides a method for making compensation for advertising on a display device of a home appliance.

### SUMMARY OF THE INVENTION

Accordingly, the present invention is directed to method and system for making compensation for advertising on a display device of a home appliance that substantially obviates one or more problems due to limitations and disadvantages of the related art.

An object of the present invention is to provide method and system for making compensation to a user for advertising on a display device of a home appliance.

Another object of the present invention is to provide method and system for making compensation for advertising on a display device of a home appliance, in which payment of electricity charge is exempted as a compensation for advertising on a display device of a home appliance.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for making compensation for advertising on a display device of a home appliance includes the steps of transmitting an advertisement data desired by a user to the home appliance through a predetermined network, displaying the advertisement data on the display device of the home appliance for the user, transmitting a display result data of the advertisement data to an advertisement server, and accumulating electronic cash of a predetermined amount for the user of the home appliance according to the display result data.

The method may further include the steps of the advertisement server transmitting information on the electronic cash accumulated thus to a predetermined company server with which the user is registered.

Preferably, the display result data includes a display time period of the advertisement data. The display result data may includes a number of display times of the advertisement data.

Preferably, the method further includes the steps of the home appliance receiving a request for displaying advertisement from the user, the home appliance transmitting a message of requesting the advertisement data to the advertisement server according to the reception of the request, and the advertisement server transmitting the advertisement data to the home appliance according to the message of requesting the advertisement data.

The method may further includes the steps of the home appliance receiving a reception refusal of display of the advertisement from the user, the home appliance transmitting a message of the refusal of the advertisement data to the advertisement server according to the reception of the reception refusal, and the advertisement server stopping the transmission of the advertisement data to the home appliance according to the message of the refusal of the advertisement data.

In another aspect of the present invention, a method for making compensation for advertising on a display device of a home appliance includes the steps of displaying a predetermined advertisement data on a display device of the home appliance, producing a display result data on a result of the display of the advertisement data, accumulating electronic cash according to the display result data, and adjusting electric charge of a user based on the electronic cash accumulated thus.

The method may further includes a first communication step of the home appliance making communication with an advertisement server having the advertisement data stored therein through a predetermined network for displaying a advertisement data the user desires.

The first communication step may include the steps of the user applying an order for requesting the advertisement data the user desires, transmitting a message of the order to the advertisement server, and transmitting the advertisement data of the message to the home appliance.

The first communication step may include the steps of applying an order for refusing display of the advertisement data, transmitting a message of the order to the advertisement server, and stopping transmission of the advertisement data according to the message.

The method may further include a second communication step for the home appliance making communication with the advertisement server through the network for accumulating the electronic cash.

The second communication step may include the steps of transmitting the display result data to the advertisement server, and transmitting information on the electronic cash accumulated based on the display result data received at the advertisement server to the home appliance.

The method may further include a third communication step for the advertisement server making communication with the electric company server through the network for adjustment of the electric charge.

The third communication step may include the steps of transmitting information on the electronic cash accumulated thus to the electric company server, and transmitting a result of adjustment of the electric charge of the user according to information on the electronic cash.

The second communication step may further include the step of transmitting a result of adjustment of the electric charge of the user received from the electric company server in the third communication step.

In another aspect of the present invention, a system for making compensation for advertising on a display device of a home appliance includes the home appliance having the display device for displaying information including an advertisement data the user request, and a microcomputer for producing a display result data on use of the advertisement data, an advertisement server for providing a predetermined advertisement data to the home appliance, and accumulating electronic cash for the user according to the display result data produced at the home appliance, and an electric company server for adjusting the electric charge of the user based on the electric cash accumulated thus at the advertisement server.

The system may further include a network which connects the home appliance, the advertisement server, and the electric company.

The home appliance may further include an input device for applying an order for obtaining the advertisement data thereto, a storing device for storing information including the advertisement data, and a communication device for transmission/reception of the data.

The home appliance further includes a data managing device for managing information on time when the advertisement data is displayed.

Preferably, the advertisement server transmits information on the electronic cash accumulated thus to the electric company server, receives a result of adjustment of the electronic cash adjusted at the electric company server, and transmits the result of adjustment to the home appliance.

Preferably, if the input device receives an order for refusing reception of the advertisement data, a message of refusing the advertisement data is transmitted to the advertisement server.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates a diagram of a display device of a related art refrigerator;

FIG. 2 illustrates a block diagram of a system for realizing a method for making compensation for advertising on a display device of a home appliance in accordance with a preferred embodiment of the present invention;

FIG. 3 illustrates a block diagram of the home appliance in FIG. 2;

FIG. 4 illustrates a flow chart showing the steps of a method for making compensation for advertising on a display device of a home appliance in accordance with a preferred embodiment of the present invention; and

FIG. 5 illustrates an example of summarizing data of the display in accordance with the method for making compensation for advertising on a display device of a home appliance of the present invention.

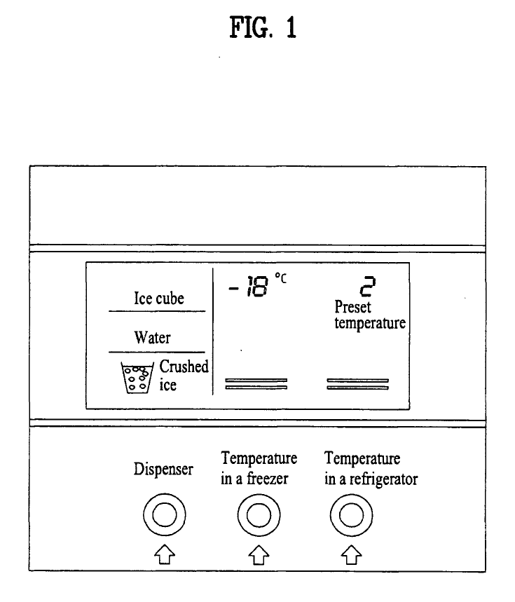

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

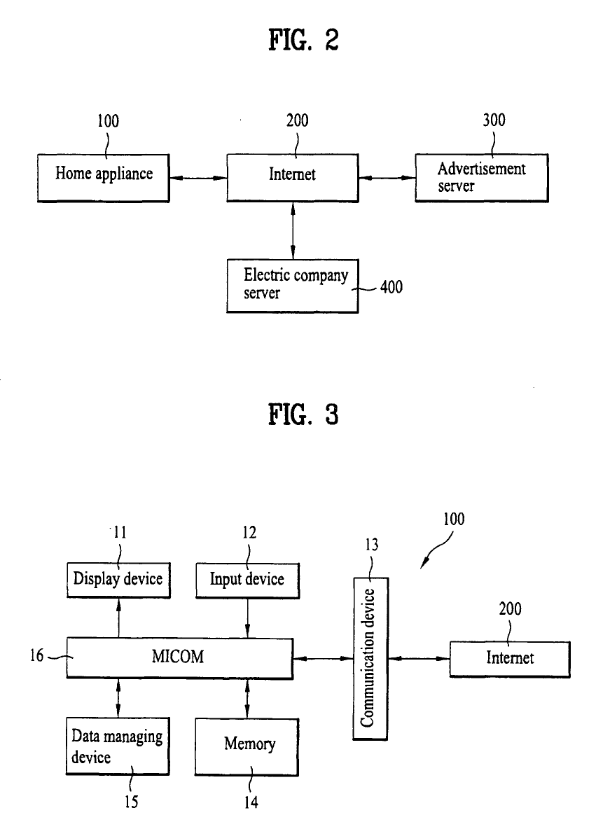

FIG. 2 illustrates a block diagram of a system for realizing a method for making compensation for advertising on a display device of a home appliance in accordance with a preferred embodiment of the present invention.

Referring to FIG. 2, the system includes an advertisement server 300 for providing a predetermined advertising data, a home appliance 100 for displaying the advertising data, an electric company server 400 for adjustment of an electric charge for the home appliance, and the internet 200 connected to the advertisement server 300, the home appliance 100, and the electric company server 400, respectively.

However, the present invention is not limited in the embodiment. The electric company server may be any other company server with which the user is registered. For example, the company server may include a credit card company server, an on-line market server and so on. The company server may adjust the amount of electric cash according to the user's consuming the electric cash based on a result of displaying the advertising data.

The advertisement data includes at least video and audio data, a text data, and so on for advertisement of a company, goods or service, and so on. The advertisement data may also include an advertisement time, an advertisement time period, and a number of advertisements for the advertisement to be displayed on the home appliance 100. Moreover, the advertisement data may include single advertisement (for an example, one product, or one company) or a plurality of advertisement.

The home appliance 100 receives and stores the advertisement data from the advertisement server 300 through the internet 200, and displays the advertisement for th4e user. The home appliance 100 also calculates a result of display of the advertisement data, and transmits the calculated display result to the advertisement server 300.

In detail, if the user applies a request for receiving the advertisement data to the home appliance 100, the home appliance 100 transmits a message of the request for receiving the advertisement data to the advertisement server 300 through the internet 200, and, in response to this, receives the advertisement data from the advertisement server 300.

Then, the home appliance 100 stores the advertisement data, and displays the video and audio data, and the text data included in the advertisement data. The advertisement data may be displayed depending on preset advertisement time, advertisement time period, and a number of advertisement times. Of course, the user may set the advertisement time, advertisement time period, and number of advertisement times, separately.

Also, the home appliance 100 calculates a result of display of the advertisement, produces a display result data calculated thus periodically, or according to a user's order, and transmits the display result data to the advertisement server 300. The display result data includes information on the display time period, or display time, and so on in addition to a number of times of display of the advertisement.

If the user applies a refusal of reception the advertisement data while the home appliance 100 is performing a service of displaying the advertisement presently, the home appliance 100 transmits a message of the refusal of the reception of the advertisement data to the advertisement server 300. Then, the home appliance has no advertisement data applied thereto, and, even if the advertisement data is received, the home appliance erases the advertisement data so that the advertisement data is not displayed.

The home appliance includes all domestic machines used in a home, inclusive of a refrigerator, a washing machine, an air conditioner, and so on.

Next, the advertisement server 300 transmits the advertisement data to the home appliance 100, and receives the display result data from the home appliance 100. Moreover, the advertisement server 300 accumulates electronic cash for the user of the home appliance 100 based on the display result data, and transmits information on the electronic cash to the electric company server 400.

In detail, upon reception of the message of requesting the advertisement data from the home appliance 100, the advertisement server 300 searches predetermined storage means (not shown) for an advertisement data stored therein, to select a proper data, or transmits entire advertisement data to the home appliance 100.

As described before, the advertisement data includes the video and audio data, the text data, and so on, and, in addition to this, may include the advertisement time, or the advertisement time period, or the number of advertisement times for displaying the advertisement.

The advertisement server 300 receives the display result data of the advertisement data from the home appliance, and accumulates the electronic cash for the user according to the number of display times or display time period or the display time of the advertisement included in the display result data. Moreover, the advertisement server transmits information on the electronic cash accumulated thus to the home appliance 100 for user's notice of the information on the electronic cash.

The information on the electronic cash includes a sum of the electronic cash, and user information for identification or verification of the user.

The advertisement server 300 also transmits information on the electronic cash accumulated thus to the electric company server 400, and receives a result of adjustment of the electronic cash (for an example, a detail of the reduction) from the electric company server 400 and transmits the result to the home appliance 100 of the user.

The advertisement server is a server operated by an advertiser, or an advertising company who provides the advertising data.

The electric company server 400 receives information on the electronic cash from the advertisement server 300, adjusts electric charges charged to the user based on the information on the electronic cash, and transmits a result of adjustment to the advertisement server 300 or the home appliance 100.

In detail, the electric company server 400 is a server for storing information on the electric charge of the user, charging the electric charge according to the information, and receives the electric charge. The electric company server 400 receives information on the electronic cash of the user from the advertisement server 300, and reads the electric charge charged to the user of the home appliance. Then, the electric company server 400 reduces the electric charge read thus by the electronic cash, and transmits a reduction result to the advertisement server 300. Thereafter, an adjustment of actual cost is made between the advertisement server 300 and the electric company server 400. Of course, the electric company server may transmit an adjustment result of the electronic cash to the home appliance, directly.

It is required that the internet 200 is known as a collective concept including a wideband network, such as a network of TCP/IP protocol and/or all elements (for an example, an internet service provider server or the like) required for short distance network communication.

FIG. 3 illustrates a block diagram of the home appliance in FIG. 2.

Referring to FIG. 3, the home appliance 100 includes a display device 11 for displaying an advertisement data, an input device 12 for receiving orders on reception and refusal of the advertisement data from the user, a communication device 13 for making data communication through the internet 200, a storing device 14 for storing the advertisement data, and the display result data of the advertisement data, a data managing device 15 for managing the data, and a microcomputer (MICOM) 16 for controlling above devices.

The display device 11 includes a monitor and/or an audio device for expressing video, audio, and text data of the advertisement data, and may have a kind of touch screen shape together with the input device 12.

The input device 12 includes a key board or the like for the user to apply order thereto to make the home appliance and the advertisement server to communicate with each other. The user applies the order of reception request or reception refusal of the advertisement data to the input device. The order of reception request or reception refusal applied thus is transmitted to the microcomputer 16. The order of reception request or reception refusal may also be reception request or reception refusal for the advertisement data of a specific field.

The input device 12 may also receive the display time, the display time period, or a number of display times of the advertisement data received thus from the user. The input device 12 may also receive orders for production of the display result data on the advertisement data and transmission of the display result data produced thus to the advertisement server 300 from the user.

The communication device 13 is a communication interface, such as a wired or wireless modem which enables data communication between the microcomputer 16 of the home appliance 100 and the internet 200, mounted inside or outside of the home appliance 100.

The storing device 14 stores the order of the reception request or reception refusal from the input device 12, the advertisement data and information on display of the advertisement data (for an example, the display time, the display time period, and a number of display times, and so on), and information on production and transmission of the display result data. The order of the reception request or reception refusal, and the display result data includes user information, and the user information includes an ID/pass word, or certificate, or the like.

The data managing device 15 is provided for calculating the display result data including the display time, the display time period, and a number of the display times of the advertisement. The data managing device is included in a program for calculating the display result data.

The data managing device 15 may be operated together with a clock for presenting the present time to the display device 11. The data managing device 15 calculates the display result data of the advertisement data periodically or upon reception of request from the microcomputer 16.

The microcomputer 16 transmits the reception request or reception refusal of the advertisement data to the advertisement server 300 by using the communication device 13, and displays the advertisement data received from the advertisement server on the display device 11. The microcomputer 18 also transmits the display result data on the advertisement display to the advertisement server 300 through the communication device 13. Of course, the microcomputer 16 may have the data managing device built therein for production of the display result data on the advertisement display, or perform entire operation of the home appliance.

In the meantime, the home appliance 100 may further include a main microcomputer (not shown) for controlling operation of the home appliance. There may be communication lines connected between the main microcomputer and the microcomputer 16 for controlling the home appliance while making the data communication. The home appliance 100 may be provided with power supply means (not shown) for supplying power required for elements of the home appliance.

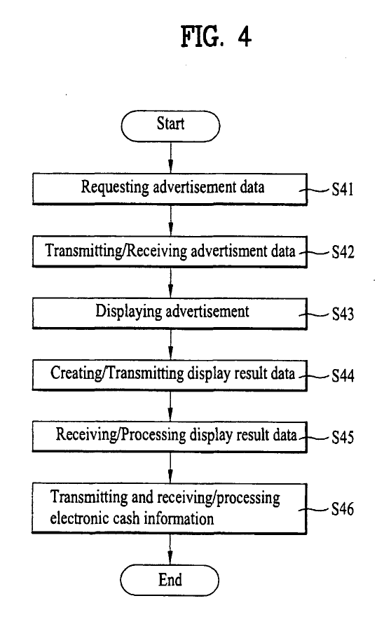

FIG. 4 illustrates a flow chart showing the steps of a method for making compensation for advertising on a display device of a home appliance in accordance with a preferred embodiment of the present invention. The method for making compensation for advertising on a display device of a home appliance in accordance with a preferred embodiment of the present invention will be described with reference to FIGS. 2 to 4.

Referring to FIGS. 2 to 4, the method includes the steps of displaying a predetermined advertisement data on a display device of the home appliance, producing a display result data on a result of the display of the advertisement data, accumulating electronic cash according to the display result data, and adjusting electric charge of a user based on the electronic cash accumulated thus.

In order to display an advertisement data the user desires, the home appliance 100 has a first communication step for communication with an advertisement server 300.

To do this, the user applies an order of reception request or reception refusal of the advertisement data to an input device. Then, a microcomputer 16 receives the order of reception request or reception refusal of the advertisement data applied to the input device 12, generates a message on the order, and transmits the message to the advertisement server 300 (S41).

If the message from the microcomputer is the message on reception refusal of the advertisement data, the advertisement server 300 transmits no advertisement data to the home appliance 100. However, if the message from the microcomputer is the message on reception request of the advertisement data, the advertisement server 300 transmits the advertisement data to the home appliance 100 (S42).

Thereafter, the microcomputer 16 receives the advertisement data, stores the advertisement data in the storage device 14, and reads the advertisement data stored in the storing device 14 thus. Then, the microcomputer 16 displays the advertisement data on a display device 11 according to information on display of the advertisement included in the advertisement data, or information on display of the advertisement having the user applied thereto (S43).

Every time the advertisement display of the advertisement data starts, the microcomputer 16 increases a number of display times (an initial value is ‘0’) of the advertisement data by ‘1’, and receives the present time from the data managing device 15 and stores the time as a starting time of display of the advertisement data.

Upon finishing the display of the advertisement data, the microcomputer 16 receives the present time from the data managing device 15 again, and stores the time as an advertisement data display finish time. According to those steps, the microcomputer 16 stores a number of display times, the display time, the display time period, and so on of the advertisement data in the storing device 14.

Next, in order to accumulate the electronic cash which is a price of the advertisement data display, the home appliance 100 has a second communication step for communication with the advertisement server 300.

The microcomputer 16 produces the display result data including the display time, or a number of display times, display time period, and so on of the advertisement data stored in the storing device 14 periodically, or upon request of the user. Then, the microcomputer 16 transmits the display result data to the advertisement server 300 through the communication device 13 (S44).

The advertisement server 300 receives the display result data, and accumulates the electronic cash for the user with reference to the display result data. The display result data which indicates an extent of display of the advertisement includes a number of display times, the display time period, the display time of the advertisement data, and the electronic cash is accumulated according to predetermined references for each of items of the display result data. In this instance, the advertisement server 300 may inform information on the electronic cash accumulated based on the display result data to the home appliance 100 (S45).

Next, in order to make adjustment of the electric charge, the advertisement server 300 has a third communication step for communication with an electric company server 400.

The advertisement server 300 transmits information on the electronic cash to the electric company server 400. The information on the electronic cash includes total electronic cash and user information. Then, the electric company server 400 senses the user information including information on the electronic cash received thus, and searches for the electric charge of the user stored therein. Thereafter, the electric company server 400 processes the information on the electronic cash by deducting the electronic cash from the electric charge (S46).

Then, the electric company server 400 transmits a result of the adjustment of the user's electric charge to the advertisement server 300, and in return the advertisement server 300 transmits the adjustment result to the home appliance 100. Of course, the electric company server 400 may transmit the adjustment result of the user's electric charge to the home appliance, directly.

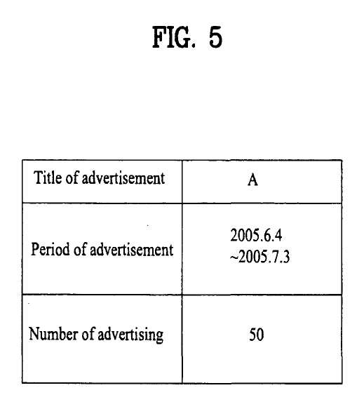

FIG. 5 illustrates an example of summarizing data of the display in accordance with the method for making compensation for advertising on a display device of a home appliance of the present invention.

Referring to FIG. 5, the display result data includes, for an example, a title of the advertisement, a display time period of the advertisement, a number of display times of the advertisement, and so on. The advertisement title may be an object of the advertisement (for an example, a name of a company, or a name of a product) or identification symbols for advertisement data including a plurality of advertisements.

As has been described, the method and system for making compensation for advertising on a display device of a home appliance has the following advantages.

An advertising effect can be maximized as a useful advertisement is displayed upon request from the user.

The compensation of the electronic cash for the display of advertisement improves usefulness of the home appliance.

A compensation can made for a voluntary participation of the user by enabling to use the electronic cash for payment of the electric charge.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for making compensation for advertising on a display device of a home appliance comprising the steps of:
transmitting an advertisement data desired by a user to the home appliance through a predetermined network;
displaying the advertisement data on the display device of the home appliance for the user;
transmitting a display result data of the advertisement data to an advertisement server; and
accumulating electronic cash of a predetermined amount for the user of the home appliance according to the display result data.

2. The method as claimed in claim 1, further comprising the step of the advertisement server transmitting information on the electronic cash accumulated thus to a predetermined company server with which the user is registered.

3. The method as claimed in claim 1, wherein the display result data includes a display time period of the advertisement data.

4. The method as claimed in claim 1, further comprising the steps of:
the home appliance receiving a request for displaying advertisement from the user;
the home appliance transmitting a message of requesting the advertisement data to the advertisement server according to the reception of the request; and
the advertisement server transmitting the advertisement data to the home appliance according to the message of requesting the advertisement data.

5. The method as claimed in claim 4, further comprising the steps of:
the home appliance receiving a reception refusal of display of the advertisement from the user;
the home appliance transmitting a message of the refusal of the advertisement data to the advertisement server according to the reception of the reception refusal, and
the advertisement server stopping the transmission of the advertisement data to the home appliance according to the message of the refusal of the advertisement data.

6. A method for making compensation for advertising on a display device of a home appliance comprising the steps of:
displaying a predetermined advertisement data on a display device of the home appliance;
producing a display result data on a result of the display of the advertisement data;
accumulating electronic cash according to the display result data; and
adjusting electric charge of a user based on the electronic cash accumulated thus.

7. The method as claimed in claim 6, further comprising a first communication step of the home appliance making communication with an advertisement server having the advertisement data stored therein through a predetermined network for displaying a advertisement data desired by the user.

8. The method as claimed in claim 7, wherein the first communication step includes the steps of;
the user applying an order for requesting the advertisement data the user desires,
transmitting a message of the order to the advertisement server; and
transmitting the advertisement data of the message to the home appliance.

9. The method as claimed in claim 7, wherein the first communication step includes the steps of;
applying an order for refusing display of the advertisement data,
transmitting a message of the order to the advertisement server, and
stopping transmission of the advertisement data according to the message.

10. The method as claimed in claim 7, further comprising a second communication step for the home appliance making communication with the advertisement server through the network for accumulating the electronic cash.

11. The method as claimed in claim 10, wherein the second communication step includes the steps of;
transmitting the display result data to the advertisement server, and
transmitting information on the electronic cash accumulated based on the display result data received at the advertisement server to the home appliance.

12. The method as claimed in claim 7, further comprising a third communication step for the advertisement server making communication with the electric company server through the network for adjustment of the electric charge.

13. The method as claimed in claim 12, wherein the third communication step includes the steps of;
transmitting information on the electronic cash accumulated thus to the electric company server, and
transmitting a result of adjustment of the electric charge of the user according to information on the electronic cash.

14. The method as claimed in claim 13, wherein the second communication step further includes the step of transmitting a result of adjustment of the electric charge of the user received from the electric company server in the third communication step.

15. A system for making compensation for advertising on a display device of a home appliance comprising:
the home appliance including the display device for displaying information including an advertisement data desired by a user, and a microcomputer for producing a display result data on use of the advertisement data; and
an advertisement server for providing a predetermined advertisement data to the home appliance, and accumulating electronic cash for the user according to the display result data produced at the home appliance.

16. The system as claimed in claim 15, further comprising an electric company server for adjusting the electric charge of the user based on the electric cash accumulated thus at the advertisement server.

17. The system as claimed in claim 15, wherein the home appliance further includes an input device for applying an order for obtaining the advertisement data thereto, a storing device for storing information including the advertisement data, and a communication device for transmission/reception of the data.

18. The system as claimed in claim 17, wherein the home appliance further includes a data managing device for managing information on time when the advertisement data is displayed.

19. The system as claimed in claim 16, wherein the advertisement server transmits information on the electronic cash accumulated thus to the electric company server, receives a result of adjustment of the electronic cash adjusted at the electric company server, and transmits the result of adjustment to the home appliance.

20. The system as claimed in claim 17, wherein, if the input device receives an order for refusing reception of the advertisement data, a message of refusing the advertisement data is transmitted to the advertisement server.
